(19) United States
(12) Patent Application Publication
(10) Pub. No.: US 2020/0012745 A1
(43) Pub. Date: Jan. 9, 2020

(54) System and Method for Secure Data Management and Access Using Field Level Encryption and Natural Language Understanding

(71) Applicant: Simon I. Bain, Pacific Grove, CA (US)

(72) Inventor: Simon I. Bain, Pacific Grove, CA (US)

(21) Appl. No.: 16/030,751

(22) Filed: Jul. 9, 2018

(51) Int. Cl. G06F 17/30; H04L 9/32; G06N 99/00

(52) U.S. Cl. CPC G06F 17/30979; G06N 99/005; G06F 17/30404; H04L 9/3247

(57) ABSTRACT

A system and method for secure data management and access using field level encryption and natural language understanding. The system includes a component for securely managing queries to a database by pushing the encryption and data access responsibilities to the individual fields in the database. Dynamically allocated ports are further used to separate the functions of query processing from the requestor. The system uses a standard SQL front-end but all access control, encryption, and data management are handled by the field. The actual data may not reside in the field but may be pointed to by a data pointer. The system also includes a natural language understanding component that processes queries similarly to how people process language, by maintaining context to disambiguate terms and by allowing the use of new terms by learning which known terms they may refer to and then executing the query and returning the response in natural language form expected by the user.

### TECHNICAL FIELD

The present invention relates generally to the field of computer science and information technology, more specifically to natural language processing (understanding), database technology, encryption, and document management.

### BACKGROUND OF THE INVENTION

Natural language interfaces that utilize either voice recognition or any other form of text input are becoming commonplace and are being applied in many different domain areas. The most common products available today include virtual assistants such as AMAZON ALEXA™, APPLE SIRI™, and GOOGLE ASSISTANT™, but the underlying technology is also pervasive in voice driven chat bots commonly used in customer service web sites.

The literature historically has used the term “natural language processing” to mean any processing that occurs on input text that could be sourced from a speech recognition system or any text input device such as a keyboard. In this application, the term “natural language understanding” is used to more clearly mean more than mere processing, but added semantic processing that adds meaning and context to the input words. Further, a “natural language interface” is any interface that accepts any form of linguistic textual input where natural language is a primary (or only) input source.

There are two key problems with the state of the art technology in natural language interfaces coupled to database queries and transactions that the present invention addresses:

First, implementing a natural language interface in a new domain can be time and resource intensive because the system must have deep contextual knowledge about the subject matter in order to carry on a natural “conversation” with the user. When people speak to other people, we commonly do not use the same words in exactly the same way, and yet we understand each other because we are able to dynamically map new words or new meaning for known words onto known words with known meanings. These computer-based systems have to build that knowledge before such mappings can take place. Also, the knowledge, when built this way, tends to be fragile where mistakes are common.

The present invention provides a way to build language context independent of the application domain, such that it can be used to quickly develop context awareness in a new domain. Because this context is persistent and cross-domain, it also tends to be far more robust than current solutions to this problem.

Second, most of these systems rely on access to databases in order to respond to the user's natural language queries. A common problem with such databases is securing their contents. Modern database security consists of mechanisms for securing the entire database structure usually by securing access to the database itself. Even if the contents of a database are encrypted, if access to the database is breached, that person or system will usually have access to the unencrypted data stored therein. This fundamental flaw in modern database technology has been the root cause of untold damage due to data breaches.

The present invention solves this critical problem by moving the encryption layer to the field level within a table and separating functions (also at the field level) of data storage and access. This solution fundamentally changes the way the database is structured and where the data can be stored.

### Natural Language Understanding

There are many different methods and approaches to enable a computer to recognize speech, including:
Named Entity Recognition (NER): Where a system is primed with a number of entities which are mapped to various nouns within a system.
Natural Language Generation: The conversion of database contents into a human readable format.
Question Answering: Where there is a specific question asked and a specific answer that is returned.
Sentiment Analysis: Used to analyze trends in a dataset or a set of documents.
Other Methods: See: https://en.wikipedia.org/wiki/Natural_language_processing

There are pros and cons to all the known methods, and while they are all able to perform reasonably well within their specific implemented problem domain, on their own, they are rarely able to do a complete job. The Natural Language Understanding (NLU) engine in the present invention takes a hybrid approach using a selection of methods and combining them into a single process. This methodology enables the NLU to be accurate, have faster implementation times, and requires a much less time-consuming learning curve than other more static approaches.

### Field-Level Database Encryption

Databases have a long and useful history, dating back to millennia past when humans first started to place lists onto stone tablets. Modern databases of the computer age started to come to light in the late 1960s with the Navigational Database (see https://en.wikipedia.org/wiki/Navigational_database). These began with the rise of magnetic media for storage. In the early 1970s the first Relational Databases (RDMS) (see https://en.wikipedia.org/wiki/Relational_database) started to come into use, and today these are still the predominant database structure in use in the marketplace. Moving into the late 1970s and early 1980s, a method to query a database took hold (Structured Query Language, or SQL) (see https://en.wikipedia.org/wiki/SQL) and simple standard querying of data was now possible. In the 1990s came Object Databases (see https://en.wikipedia.org/wiki/Object_database) and in the 2000s In Memory Databases (see https://en.wikipedia.org/wiki/In-memory_database).

Despite the impact that technical evolution has had on database technology, the use for any database has not fundamentally changed—its purpose is still to store data for subsequent retrieval. However, in the early 2000s something important happened to that data. Primarily due to inexpensive mass storage, the quantity of data stored in databases exploded. The amount of data that was being collected, stored, queried and analyzed is now on a massive scale that is orders of magnitude larger than envisioned when early concepts of databases were developed. Also, this data itself now has intrinsic monetary value. So much value in fact, that the data itself is being stolen to be sold to the highest bidder, as evidenced every time there is a major data breach.

The current dated systems of databases are not able to keep up with this trend. While the majority of them are able to encrypt the data stored, this encryption is carried out in such a way that anyone (human or machine) that has access to the system at any administration level generally also has access to the plain unencrypted data. There is essentially a single point of failure at the door to the database. This design flaw has allowed many millions of dollars to be stolen in the last few years from many different and diverse organizations.

Database security and how data held within a database is secured is under increasing scrutiny. As such, a new approach to data storage is required. The approach must enable the same easy access that has proven to work well over the past two decades with SQL. It must also be able to integrate and migrate data to and from other databases, but also should re-think how data should be stored, what access privileges should be granted and how they should be granted, and how to enable data migration without data compromise.

The In-Memory Secure Database disclosed herein is the solution to this problem. By taking the encryption layer and placing it into the database field and splitting the field into separate items to manage not just the data, but also its metadata and the structure, the system maintains access to the rules which enable modern applications to run.

### SUMMARY OF THE INVENTION

### Technical Problem

The present invention addresses security problems pertaining to transactions with databases and also the problem of people interacting with applications and databases using natural language.

### Solution to the Problem

The present invention solves the database security problem by shifting security concerns to the field level. An external application transmits a signed and encrypted query to the communication layer of the system using a dynamically allocated port that is created by the communication layer especially for this query transaction. On arrival at the communication layer, the query is checked for signature and it is passed to the SQL engine where it is parsed to form a valid SQL query. The SQL engine then requests another dynamically allocated port to the database structure which it uses to send the query to the database structure where it is verified. The database structure then uses the table structure to determine the relevant tables needed for this query. The table layer retrieves the necessary fields. The fields themselves actually determine whether or not access to their data will be allowed. They contain access control of their own access key and an encryption engine for encrypting and decrypting their data which is pointed to via a data pointer. The data need not be stored within the database itself.

The natural language problem is solved using a natural language understanding system that processes input linguistic text similarly to the way humans process natural language. The process begins by determining whether the input is a valid question or command. If the system does not recognize the input type, then it will ask the user to re-phrase their query. The system contains a context recognizer that can disambiguate input text streams when imprecise words are used intended to mean a specific thing. The system then determines if the entities in the input stream are valid subjects of a query that can be formed and send to a database for processing. If they are not, the system will again ask the user to re-phrase their query and it will learn what new words map to known words in its entity type table. This table can be stored in a persistent store to facilitate fast transition to new topic domains for new application areas. Finally, the system accesses the database with the query and reforms the response into natural language in a format expected by the user.

### Advantages of this Solution

The secure database is a preferred solution for several reasons. The dynamically allocated ports greatly reduce the possibility of unauthorized access. The database requires far less memory and processing and less management of the database itself because management has been pushed down to the field level. Data migration is far easier because fields can be handled independently of the table in which they reside.

The natural language system is a preferred solution because it can immediately differentiate between commands and questions coming from the user. The ability to determine context allows users to talk more naturally where the system is able to figure out what objects and relationships they are referring to by using past contextual statements. The system also allows users to use different words to mean the same things, as people normally do, by maintaining and learning matches between known words and incoming new words.

### BRIEF DESCRIPTION OF THE DRAWINGS

FIG. 1 is a high level box diagram of the key components of the present invention.

FIG. 2 is a flow diagram of the present invention where the query to the database is signed and encrypted.

FIG. 3 is the same as FIG. 2 but where the query to the database is not signed or encrypted.

FIG. 4 is an expanded view showing the detail of how the query is processed at the field level.

FIG. 5 is a flow diagram of the natural language understanding component of the present invention.

FIG. 6 is a flow diagram showing a request passing through a secure gateway, the NLU engine, and then to the secure database for processing.

### DESCRIPTION OF THE INVENTION

Securing access to databases has been a problem for as long as there have been databases. The advent of web-based applications and more recently, voice (natural language) interfaces as a means to access those databases raises unique problems.

A standard database requires a number of things to take place if it is to access encrypted data:
A key store, which itself is encrypted using a master key
User credentials, to access the key store, and
Multiple database services to run and manage the encryption, SQL, and key store integration.

However, a key feature of the present invention is that it only requires either:
A known user, or
A known device,
Either of which can have ‘hidden’ access to data stored in one or multiple fields without necessarily having full access to the entire database.

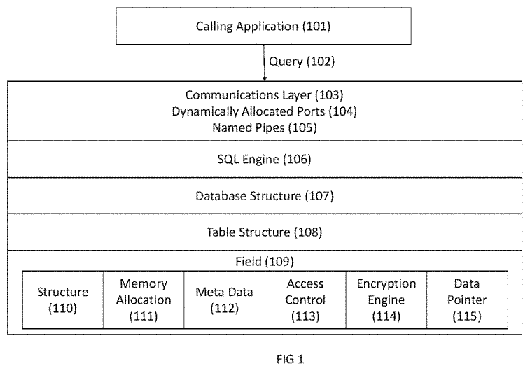

As shown in FIG. 1, a previously authenticated known user or known device from an external calling application (101) may have direct access via the communication layer (103) to specific fields (109) in the database where the actual data may or may not reside within the database itself. The data may be pointed to (115) by the appropriate field. Access control (113) is managed at the field level.

This means that the database service requires less memory and processing power, less management of resources for the database itself, and controls field level access of data down to an individual or device. The power of this is that there can be multiple IoT (Internet of Things) devices accessing a single database and table, yet each may only access a single field managed by that database regardless of the SQL query that has been sent.

This provides a more secure and granulated result set to be used within IoT and Artificial Intelligence applications. In addition, the present invention uses dynamically allocated ports (104), further reducing the likelihood of successful attacks.

### The Secure Database

FIG. 1 shows the basic structure of the secure database where a query flows through each subsequent layer before access is permitted. Each of these layers is described below.

Communications Layer (103): This layer manages how a query accesses the database. It manages the flow process. It does not manage access to the data held or to any pointer to data (115), but only to the physical service. It is itself a Containerized Memory Block, which when called as a service, will open a TCP port to enable a single, one-time connection from the calling application (101). It will only accept digitally signed requests and can block all access to the underlying database structures and data.

SQL Engine (106): This is a standard SQL engine that recognizes a number of SQL 92 compliant commands, including commands to query, create and modify tables and data. The SQL engine is the only access available to the database structure (107).

Database Structure (107): Each database that the server creates has a structure block. Like the Communications Layer, this is a Containerized Memory Block, which also shares the ability to manage dynamic port access. However, unlike the Communications Layer, the Database Structure will only allow access from the SQL Engine. This means that any attempt to bypass the SQL Engine to read the data directly will fail.

Table Structure (108): A database is made up of one or more tables. The Table Structure is the housing for each table within a database. It manages the database fields and makes sure that all database integrity requirements are maintained. Tables are an essential component of the database and are a key mechanism by which SQL queries identify which fields fit the limitations of the query. Note that while table structure is essential to data access via an SQL query, no data is held at the table level nor is access controlled at the table level.

Field (109): The Field is where the data access and control takes place. It is not necessarily where the data is stored, but is more like a door with its own lock to allow access to the data. While it is preferable to store the data external to the field via the data pointer (115), the data may be contained in the field. Each field is held within its own memory block while being an object within a parent table. Each field contains the following set of elements:
Memory Allocation: (111) Manages the memory size of each field (because Data Size may change over the life of the field).
Meta Data: (112) Holds the reported data type and data storage size.
Access Control: (113) Manages the encryption key creation.
Encryption Engine: (114) Manages the encryption and decryption of the stored data at the field level.
Data Pointer: (115) A pointer to the actual stored data. This can point to any addressable memory block accessible to the service, or it may hold the data itself.

### Data Flow

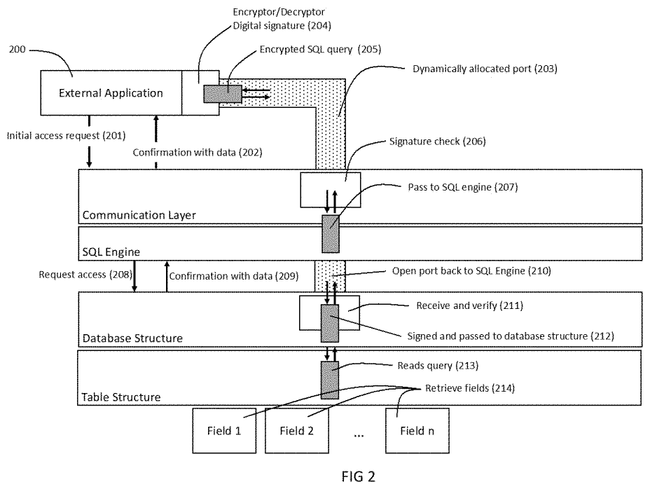

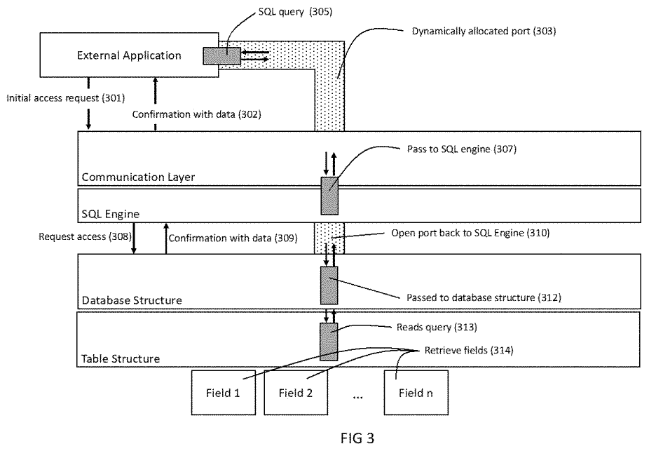

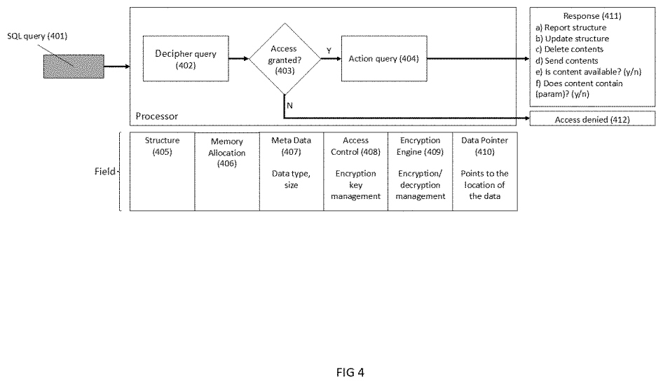

The following describes the data flow of the invention starting with a call from an external application requesting access to data held within the secure database and ending with either denial of access or the execution of the access request if allowable (see FIGS. 2 and 3).
1) Call from external application (200). An external application requests access to the database via a query. The external application sends an initial access request (201, 301) to the communication layer.
2) The communication layer creates a dynamically allocated port (203, 303) specifically for use with this one query (205, 305). The communication layer then confirms the request back to the requesting external application with necessary information (202, 302) by which the external application will access the dynamically allocated port.
3) The external application may encrypt and digitally sign the query (204) resulting in an encrypted and signed query (205). The query may also be transmitted in an unsigned and unencrypted mode (305). The query is transmitted to the communication layer using the dynamically allocated port (203, 303).
4) On receiving the request, (if encrypted and signed) the communication layer checks the signature of the request (206), and passes it along to the SQL Engine (207), together with signature and key details. If the query is not signed and encrypted, the query is passed as-is to the SQL engine (307).
5) The SQL engine processes the SQL and places a call (208, 308) to the relevant database structure to request access to the database structure.
6) The database structure receives the request and opens a port (210, 310), passing back the information to the SQL engine (209, 309).
7) The SQL engine then sends a call to the open port, signing the request with the details passed by the database structure (212, 312).
8) Once received and verified (211), the database structure opens the table structure, which translates the request (213, 313) and retrieves the required fields (214, 314) from the appropriate tables.
   Now referring to FIG. 4:
9) Each field reads the query (401) and deciphers the message (402).
10) The determination to grant access (403) is made at the field level using the encryption key (408) specific to this field.
11) If access is grantable (403), it will action the request (404). If necessary, the data will be retrieved following the data pointer (410), and decrypted by the encryption engine (409). The action to the query will be one of (411):
   Report structure (does not require access to the data pointer)
   Update contents
   Delete contents
   Send contents
   Is content available? (does not require access to the data pointer)
   Does content contain [parameter]?

The present invention brings a new approach to database storage having several unique benefits:
The database server runs with dynamically allocated ports, meaning the likelihood of attacks is greatly reduced.
The database service requires less memory and processing power, less management of resources for the database itself and controls field level access of data down to an individual or device level.
Dynamically generated keys are not stored in a key store, but are based on several factors which are shared across the whole ecosystem and also partly within the encrypted item. In general, this is a pure search where all possible factors are attempted (trial and error approach).
Determine what access privileges should be granted and how to enable data migration without data compromise.

### Natural Language Understanding

Most implementations of natural language processing (NLP) rely on the implementer and user to input questions and/or a mass of documentation to enable the system to digest, learn and create a library of syntax and understanding prior to implementation. While these systems may have some capacity for learning, the majority of the knowledge and context for the application is created during implementation. Additionally, post implementation (at runtime), the system has to learn and continue to digest information for an extended period of time to be able to understand what it is the user is looking for, with the desired end goal being a natural language dialog with the user that always responds correctly.

The present invention is different in that it creates a database which houses only basic information that enables the NLP engine to have an almost instant understanding of context. This is referred to as the “Memory Cortex.” Its role is to speed up the task of processing the text that comes from the user, and subsequently enabling the process of rapidly determining what it is that the user wants.

The Memory Cortex: This is an In-Memory database that manages the process—both the learning Artificial Intelligence (AI) and the Natural Language Processing (NLP). It consists of a number of tables, which include:

Key Word Question: Used to tell the system what input words indicate that a question is being asked. Examples of these words in the English language include:

What

Where

Who

When

How

Why

Tell Me

Key Word Command: Used to tell the system what words correspond with specific commands. Examples of these words in the English language include:

Update

Set

Can you

Create

Context Awareness: Used to let the system know if a context requirement is needed. A context requirement is one that may require a follow-on task without the initial question or command being repeated. This occurs very frequently in natural language where context is required to disambiguate meaning. As a non-limiting example:

1) User Input: “Can you tell me what the current situation is with invoice number 2144?” [Here, the system initiates a query into the database to request status on invoice 2144.]

### 2) System Output: “Paid”

3) User Input: “What date was payment made?”
[Note that the user did not state the invoice again, thus it is ambiguous and must be determined using context awareness. Context awareness is able to replace the ambiguous target invoice with “2144” using the previous query, which is then used to initiate a new query as to the date of payment for invoice 2144.]

### 4) System Output: “Jul. 5, 2012”

The present system handles context awareness in a number of ways, which include the Context Awareness Table to temporarily hold certain non-traceable events if needed in subsequent events.

It can also be seen in the example above that there could be a conflict between the Key Word Question and the Key Word Command inputs where the “hints” provided by the associated tables (503 and 504) do not agree. The system will take this into account and look at other data points, such as entity placement within the input, to resolve which is being called for.

Entity Types: This table is used to map key words to a back-end database or system that holds the data required. These types can be saved in a persistent data store for use in other applications which also serves to speed up learning time in those new applications. In the example above, the entities could have been:

Invoice

Payment

Entity Types Learnt: This is a table that holds new entities that map to entities within the Entity Types table (or the persistent store as mentioned above). It is populated when a request comes in that is not recognized. The system then asks the user to restate the query in a different way. If it finds an entity that maps to the new entity, it will map the original to it, and any subsequent use of the new entity will now be understood. As a non-limiting example:
1) User Input: “Can you tell me what the current situation is with invoice number 2144?”
2) System Output: “Paid”
3) User Input: “When was it completed?”
[Here the system does not understand the word ‘completed’. So it will now ask the user to restate the question.]
4) System output: “I am sorry I did not understand. Can you please re-phrase the question?”
5) User Input: “When was it paid?”
[The system had previously placed the word ‘paid’ into the Entity Type Table. The system now maps ‘completed’ to ‘paid’ and adds it to the Entity Type Table. Any subsequent uses of the word ‘completed’ can be understood as ‘paid’. Note that ‘completed’ may also have other meanings within the context of this application. These can be disambiguated by context.]
6) System Output: “Jul. 5, 2012”

Post Processing: Used to enable the system to do post processing on a response to make the response more human readable or conversational in nature. As a non-limiting example:

If a response came from a database and the field held a height, the system may convert the height from inches to feet if that is what the user would expect. In this instance, the post processing table would hold three items of information:

Table and field details that it will post-process: Height

Post Processing type: Math Translation

Post Processing Math Type: Divide

Post Processing Math sum: 12

The result is that the system will divide the data in the field by 12 to yield the response in feet and will return that result for presentation to the user.

Prefix: This table holds any prefix needed for a specific response, also for the purpose of making the response more human readable or conversational in nature. As a non-limiting example:

As in the example above, the system may add the word “Feet” to the answer to improve the presentation to the user. In this instance, the Prefix table would hold the following data:

Table and field details to which it will apply the prefix: Height

Prefix data: Feet.

### Process Flow

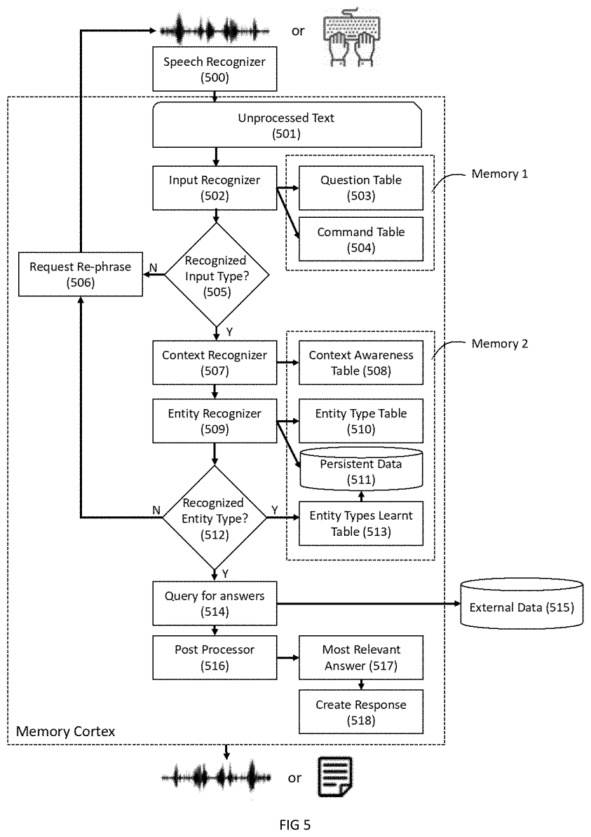

The following describes the process flow of the natural language understanding component starting with the input from a user through to the response by the system. (see FIG. 5).
1) Input from source (500): The system expects textual input in the form of words and sentences. The actual source may be text types on a keyboard, a voice processed via a speech recognition system (500), or any other source that produces linguistic text.
2) Recognize the input (502): The textual input is initially unprocessed (501). The system must recognize the input type in order to generate a query that can produce a correct response.
   a) The system uses the question table (503) to determine what type of question is being asked.
   b) It then uses the command table (504) to identify which command is present in the text.
   c) If the system does not recognize the input type for this query (505), it will generate a rephrase response (506) to the user asking for the same query using different words.
   d) On receiving a recognized type, the process proceeds to the context recognizer (507). At this point, the system knows it has valid text that may constitute a valid query.
3) Recognize the context (507): The input text is scanned to determine if there are “placeholder” words within the key words (such as pronouns where the system may not be sure to what the word refers).
   a) If there are no ambiguities, the key words of the input text are temporarily held in the context awareness table (508) to be used for disambiguating subsequent queries.
   b) If there are ambiguities (i.e. the system identifies a word which may refer to another word used previously), then the system uses the context awareness table (508) to replace the placeholder word with the actual word to which it refers.
4) Recognize entities (509): Next the system must map the key words from the context recognizer to known entities that can be used in a query.
   a) The system first looks in the entity type table (510) or to the persistent data store (511) (if present) to determine if the given key word maps directly to a known entity in the database.
   b) If a match is found, then the system confirms that the entity has been recognized (512) and the query can be made to the database.
   c) If no match is found, then the system writes the unknown entity to the entity types learnt table (513) and then confirms that no entity type was recognized (512) and the system requests that the user re-phrase their question or command (506).
      i. When the re-phrased input reaches this point in the process, the system again determines if the new key word is present in the entity type table (510). If it is not, then the system must ask again for a re-phrase of the query (506).
      ii. If the new key word is present in the entity type table (510), then the system accesses the previously unknown key word(s) in the entity types learnt table (513) and matches the previously unknown words to the known entity type and writes the new match in the entity type table (510) and the persistent data store (511).
   d) At this point in the process, the system knows it has the necessary components from which to create a valid query into the database from which it will generate its response.
5) Query the database for answers (514): Using the processed words from the textual input, the system forms a valid query that is sent to the database (515). The system receives the response and passes it to the post-processor for final handling.
6) Post-processing (516): The system takes the response from the database and forms a human readable linguistic response.
   a) If there may be more than one response or ways to respond to the query, the system determines the most relevant response (517) as determined by context (possibly requiring a re-phrase sequence) based on the request type and entity position and count.
   b) Finally, the system generates the response (518) that may include adding or removing formalism, adding or removing abbreviations, adding prefixes (see paragraph [0056]), or any other customizing of the response suitable for the given application.
7) Return response: The final response is presented to the user.

The present invention melds NLP together with AI to form Natural Language Understanding (NLU). The problem of accepting linguistic input and responding in a natural and correct way is not new. The approach in the present invention is new in a number of ways, including:
Differentiators between Questions and Commands: The system's use of re-usable tables that know when a question or a command is being offered and that can map words to valid commands suitable for generating queries is novel.
Context Awareness: Current systems do not maintain text from previous parts of a dialog in order to disambiguate words used in subsequent dialog.
Entity Recognition: Current systems do not maintain a database of entity types in order to ensure that whenever possible, the system is able to translate whatever word the user gives into a valid entity on which to generate a valid query. Moreover, this invention makes it possible to maintain such a database from domain to domain to rapidly develop deep linguistic knowledge in new subject matter without having to re-learn entity type mappings.
And most importantly, a key concept to this invention is the way that the system processes an input in the same way that a human would process a conversational input.

### The Combined System

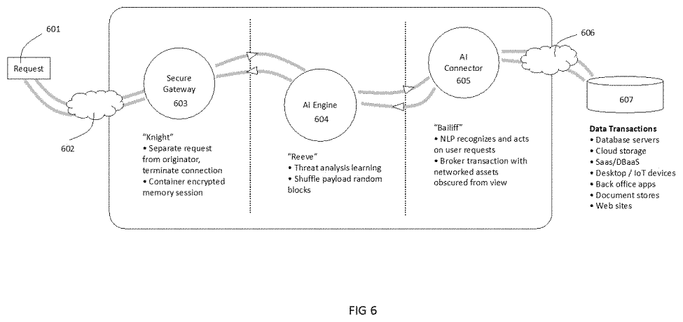

FIG. 6 depicts the secure gateway of the present invention that includes both aspects of the secure database and the natural language understanding front-end. The figure shows a request (601) that begins external to the system. That request is in some form of linguistic text as described above. Note that FIG. 6 depicts the system as a cloud-based service (602, 606) that enables the system to provide a full-functionality application as SaaS or simply database services as DBaaS (607).

The request first enters the secure gateway (603) that immediately separates the request from the originator by terminating the connection by which the request was made. This is done to secure the system from subsequent actions by the requestor. As noted above, the system utilized container encrypted memory sessions.

Next, the request is passed to the AI engine (604) that performs any threat analysis on the incoming data as well as performs any payload reshuffling which allows for this system to be scalable for any size application.

Next, the request is passed to the AI connector (605) which is where the NLU system described above resides. The request is processed to determine its meaning and the intention (expectation) of the user. If any other assets are needed for this application (such as external or third-party databases), those transactions are brokered here.

Finally, the data transaction is performed via the secure database described above. The result of the request is then passed back through all three segments of the system (605, 604, 603), and finally back to the requestor.

### INDUSTRIAL APPLICATION

The present invention has two key components each of which has industrial application. The secure database is useful in any data intensive industry requiring secure data transactions or where data transactions need to be lightweight requiring less processing power and memory. The natural language understanding component is useful in any industrial application where users will interact with a data system with natural language, spoken or non-spoken.

What is claimed is:

1. A system for secure storage and access of data contained in a database having tables, said tables having fields for receiving queries for data services from external applications, the system comprising:
a communication layer having a dynamic port allocator for creating a dynamic port connecting the communication layer to the requesting external application and for receiving said query for data services;
a database query parser coupled to the communication layer for parsing the query for data services;
a database structure having a dynamic port allocator for creating a dynamic port connecting the database structure to the database query parser;
a table structure coupled to the database structure having a table retriever for retrieving the tables in the database indicated by the query for data services, and a field retriever for retrieving the fields associated with each table retrieved by the table retriever;
at least one field coupled to the table structure having a data pointer that points to the location of the data and access control for allowing and denying access to the data pointer, and having a memory and processor for processing data access requests; and
a reporter coupled to the database structure for reporting the response to the query for data services to the requesting external application.

2. The system of claim 1 wherein the external application encrypts and digitally signs the query for data services, the system further including:
a signature checker in the communication layer for receiving, checking the digital signature of the query, and decrypting the query; and
a verifier in the database structure for receiving and verifying the query.

3. The system of claim 1 wherein the data pointer in the field holds the field data in the memory.

4. The system of claim 1 wherein the field contains meta data for storing the data type and data storage size in the memory.

5. The system of claim 1 wherein the field contains memory allocation for managing the memory size of the field.

6. The system of claim 1 wherein the field contains an encryption engine for encrypting and decrypting the data as determined by the access control.

7. A method for secure storage and access of data contained in a database having tables, said tables having fields for receiving queries for data services from external applications, the steps comprising:
receiving a service request from the external application;
creating a dynamically allocated port to the external application and passing information about the port to the external application;
transmitting a signed and encrypted query from an external application;
decrypting the query and parsing the query using an SQL engine;
requesting service from the database;
creating a dynamically allocated port to the SQL engine and passing information about the port, to the SQL engine;
accessing the tables identified in the query;
retrieving the fields identified in the query;
determining if access will be allowed to the field data for each field;
accessing the field data and decrypting the data when access is determined to be allowable; and
returning the decrypted data as a response to the service request to the external application.

8. A system for database access using natural language understanding for processing user queries, the system comprising:
a text receiver for receiving the user query as unprocessed text;
a first memory;
an input recognizer coupled to the first memory and to the text receiver having a question table and a command table stored in the first memory for identifying the user query as a question or command;
a context recognizer coupled to a second memory and to the input recognizer having a context awareness table stored in the second memory for storing keywords in the query text and for retrieving said keywords in subsequent queries;
an entity recognizer coupled to the second memory and to the context recognizer having an entity type table stored in the second memory for storing new entities in the query text, and having a persistent data store for storing past entities from prior queries, and having a learnt entity type table stored in the second memory for storing learnt entities, wherein new entities stored in the entity type table are matched to existing entities in the persistent data store and the learnt entity types are stored in the learnt entity type table;
a database query engine coupled to the entity recognizer having a processor for forming and executing queries into the secure database; and
a post-processor for identifying the most relevant response to the user query and for returning the response to the user.

9. The system of claim 8 further including a speech recognizer for accepting spoken language and producing unprocessed textual output.

10. The system of claim 8 further including a re-phrase requester for prompting the user to re-phrase a query using different words than the original request.

11. A method for database access using natural language understanding for processing user queries, the steps comprising:
receiving the user query as unprocessed natural language text;
determining the input type of the query as a question or a command;
requesting a re-phrase of the query when the input type is not recognized;
disambiguating words in the user query using stored words from past inputs;
temporarily storing words in this user query for disambiguating subsequent queries;
recognizing the entities in the query using the stored entities for matching terms;
requesting a re-phrase of the query when the entity type is not recognized;
learning new matching entity types for new terms in the re-stated query and storing the new matching terms;
querying the database using the valid query;
receiving the result of the query from the database;
post-processing the result of the query to convert it to natural language in a form expected by the user; and
transmitting the post-processed response to the user.

12. A system for secure database access using natural language understanding for processing user queries from and to external applications, the system comprising:
a secure database having at least one table for receiving queries for data services from the external applications;
at least one field coupled to the table having a data pointer that points to the location of the data and an encryption engine with access control for allowing and denying access to the data pointer;
a secure gateway having a text receiver for receiving the user query as unprocessed text and for separating the request from the originating user using dynamic ports;
an AI engine coupled to the secure gateway having a threat analyzer for evaluating incoming threats and for learning new incoming threats;
an AI connector coupled to the AI engine and to the secure database, having a query processor for transforming unprocessed text from the text receiver into a database query and having a context recognizer for disambiguating words in the unprocessed text, and having an entity recognizer for determining what words in the unprocessed text correspond to valid entities in the query, and having a response processor for receiving the response from the secure database, and for forming a natural language response to the query; and
a reporter coupled to the response generator for transmitting the natural language response to the query to the user.
